(19) United States
(12) Patent Application Publication
(10) Pub. No.: US 2019/0010392 A1
(43) Pub. Date: Jan. 10, 2019

(54) COMPOSITIONS AND METHODS FOR PROVIDING FLUORESCING MATERIALS

(71) Applicant: Imerys USA, Inc., Roswell, GA (US)

(72) Inventor: Parvin GOLBAYANI, Kennesaw, GA (US)

(73) Assignee: Imerys USA, Inc., Roswell, GA (US)

(21) Appl. No.: 15/752,426

(22) PCT Filed: Aug. 11, 2016
(86) PCT No.: PCT/US2016/046592

§ 371 Date: Feb. 13, 2018

Related U.S. Application Data
(60) Provisional application No. 62/205,341, filed on Aug. 14, 2015.
(60) Provisional application No. 62/308,386, filed on Mar. 15, 2016.

(51) Int. Cl. C09K 11/65; C09K 11/02

(52) U.S. Cl. CPC C09K 11/65; B82Y 30/00; C09K 11/02

(57) ABSTRACT

Compositions and related methods for providing fluorescent compositions and their use in products are described. A composition may include an aqueous base and at least one salt compound-quantum dot composite. The composite may be configured such that the composition emits fluorescent light having an identifying characteristic different from a characteristic of a surface against which the identifying characteristic is viewed.

### CLAIM OF PRIORITY

This PCT International Application claims the benefit of priority of U.S. Provisional Application Nos. 62/205,341, filed Aug. 14, 2015 and 62/308,386, filed Mar. 15, 2016, the subject matter of which is incorporated herein by reference in its entirety.

### FIELD OF THE DESCRIPTION

The present disclosure relates to compositions and related methods for providing fluorescent compositions and their use in products.

### BACKGROUND

Markings, labels, and packaging of products are used to identify the products themselves and the source of those products. Thus, such markings, labels, and packaging help manufacturers distinguish their products from other competing products and from products from other sources. Many manufactures spend considerable resources to develop and maintain goodwill and loyalty from consumers, and such goodwill and loyalty may be tarnished if other products and sources are able to copy markings, labels, and packaging, thereby reaping the benefits of the reputation of the manufacturer. For example, name-brand manufacturers (i.e., in contrast with generic brands or counter-fit producers) rely on markings, labels and packaging to help distinguish their products from those of other competing sources. However, it may be relatively easy to mimic or copy such markings, labels, and packaging, thereby reaping the benefits of the name-brand manufacturers good-will and reputation with customers. Thus, it may be desirable to provide, markings, labels and packaging that are not easily mimicked or copied.

Markings, labels, and packaging that include a fluorescent characteristic have been used to provide a way to verify the authenticity of the source of products. Such fluorescent characteristics may take the form of a fluorescent response when the markings, labels, or packaging are irradiated with or exposed to radiation (e.g. light) having certain characteristics. In addition, fluorescent characteristics may be used in currency to verify its authenticity. Some traditional organic dyes or pigments (e.g., organic optical brightening agents) have been used to provide labels and packaging with fluorescent characteristics. However, these may suffer from a number of possible drawbacks. For example, traditional optical brighteners tend to be relatively expensive, rely on inclusion of toxic components (e.g., water-soluble aromatics), suffer from photobleaching upon repeated irradiation resulting in loss of effectiveness over time, are suspected of being allergens, teratogens, and/or endocrine disruptors, and may be easily produced allowing for counterfeits.

Coating compositions, paper making compositions, and/or sizing compositions, such as, for example, paints (oil- and water-based paints), sealants, paper coatings, architectural coatings, and industrial coatings (e.g., coatings other than paper coatings), may be used to improve the visual characteristics of a substrate and/or protect a substrate such as paper products including paper and paperboard. Traditional optical brighteners (e.g., organic brightening agents) may be used to improve the perceived whiteness and/or brightness of paper. However, traditional optical brighteners suffer from a number of the aforementioned possible drawbacks.

Thus, although traditional optical brighteners may be desirable for providing fluorescent characteristics, it may be desirable to provide compositions that result in a reduction or elimination of the presence of traditional optical brighteners, but that still provide a fluorescent response without one or more of the above-noted drawbacks of traditional optical brighteners.

### SUMMARY

There is disclosed a composition that fluoresces when irradiated with electromagnetic energy (e.g., light). According to an aspect, the composition may be configured to emit a fluorescent response when irradiated with electromagnetic energy at a predetermined wavelength. The disclosed composition may include a base material or matrix material. In various aspects, the base material may comprise a fusible powder, an aqueous composition, or a solvent composition (e.g., organic solvent composition) and at least one salt compound-quantum dot composite.

The composition may be configured for an application that takes advantage of a fluorescent response. Related products that include such a composition are also disclosed. Non-limiting examples of such products include a coating composition, a paper making composition, a sizing composition, an ink composition, a varnish composition, and a polymer composition.

There is also disclosed a marking, label, or packaging for identifying at least one object, or source of the object, and may include a surface associated with the label or packaging and a composition associated with the surface. The composition may include an aqueous base and at least one identifying additive. The at least one identifying additive may include at least one salt compound-quantum dot composite. The at least one additive, which has already been described herein, may be configured such that the composition emits fluorescent light having an identifying characteristic.

There is additionally disclosed a method for providing identifying markings on paper or packaging that may include providing at least one composition in the paper or packaging, or on a surface of the paper or packaging. The composition may include at least one identifying additive including a salt compound-quantum dot composite. The at least one identifying additive may be configured such that the composition emits fluorescent light having an identifying characteristic, for example, in the presence of ultraviolet light or infrared radiation.

According to another aspect, a composition may include a base material or matrix material and an optical brightener including at least one salt compound-quantum dot composite. The composition may be configured as at least one of a coating composition, a paper making composition, an ink composition, and a sizing composition.

According to yet another aspect, a method for reducing traditional optical brighteners in a composition may include adding to the composition a first optical brightener. The first optical brightener may include at least one salt compound-quantum dot composite. The method may further include adding to the composition a second optical brightener, wherein the second optical brightener does not include the at least one salt compound-quantum dot composite. According to a further aspect, the second optical brightener may include at least one of sulfonated triazole stilbenes, di-sulfonated stilbene biphenyl, coumarins, imidazolines, diazoles, triazoles, benzoxazolines, and biphenyl-stilbenes.

Exemplary objects and advantages will be set forth in part in the description which follows, or may be learned by practice of the exemplary embodiments. It is to be understood that both the foregoing general description and the following detailed description are exemplary and explanatory only and are not restrictive of the invention, as claimed.

### BRIEF DESCRIPTION OF THE DRAWING

The accompanying drawing, which is incorporated in and constitutes a part of this description, illustrates an exemplary embodiment and together with the description, serves to explain principles of the embodiments.

FIG. 1 is a graph showing the FTIR result for the 1:1 ratio PCC-CQD composite, the 1:5 ratio PCC-CQD composite, and the gelatin.

### DESCRIPTION OF EXEMPLARY EMBODIMENTS

As used herein, the terms “fluorescence”, “fluoresce”, or “fluorescent response” refer to the emission of electromagnetic energy (e.g., light) by a substance that has absorbed light or other electromagnetic energy or radiation. The emitted light has a longer wavelength, and therefore lower energy, than the absorbed radiation. However, it is meant to generally encompass irradiation at one wavelength and emission of light at a different wavelength. Examples of fluorescence that can be achieved according to the present disclosure include UV to Visible (the material e nits visible light after being irradiated with UV light); UV to UV (wherein the emitted and irradiated wavelengths are different); UV to Near IR; Visible to Near IR; and IR to Visible.

As used herein the term “UV” or “ultraviolet” light refers to UVA (having a wavelength ranging from 300 nm to 400 nm); UVB (having a wavelength ranging from 280 nm to 300 nm); and UVC (having a wavelength ranging from 100 nm to 280 nm).

As used herein the term “Near IR” or “near infrared” light refers to radiation having a wavelength ranging from 700 nm to 3 microns.

As used herein the term “IR” or “infrared” light refers to radiation having a wavelength ranging from 700 nm to 1 mm.

As used herein, “dopant” refers to a small amount of an impurity that is an intentionally added to another material, such as an impurity intentionally added to a carbonate matrix.

As used herein, a “doped” material refers to a material in which a dopant was intentionally introduced during production. For example, a “doped carbonate” refers to a carbonate, such as CaCO₃, MgCO₃, BaCO₃, or mixtures thereof, in which a small impurity was intentionally added to change or induce fluorescent response when the carbonate was made.

### Salt Compound-Quantum Dot Compositions

According to certain embodiments, quantum dots are combined with salt compounds to form salt compound-quantum dot compositions that fluoresce. In certain embodiments, the salt compound-quantum dot compositions are salt compound-carbon quantum dot compositions. As used herein, “carbon quantum dot” refers to quantum dots produced from organic materials, rather than metal or semiconductor materials. As such, the salt compound-carbon quantum dot composition avoids toxicity issues that may be associated with materials derived from metal or semiconductor materials. Hereinafter, embodiments of the present invention may tend to be discussed in terms of calcium carbonate. However, the invention should not be construed as being limited to such embodiments.

In certain embodiments, a composition is provided including a base material or matrix material and a salt compound-carbon quantum dot composition incorporated therein. The composition emits a fluorescent response when irradiated.

In some embodiments, the base material comprises a resin, a fusible powder, an aqueous solution, and/or a solvent composition.

According to certain embodiments, the salt compound may comprise an alkaline earth metal compound such as an alkaline earth metal carbonate. The alkaline earth metal carbonate may comprise a calcium carbonate, such as a precipitated calcium carbonate. According to other embodiments, the alkaline earth metal carbonate may include at least one of barium carbonate and magnesium carbonate in combination with or as an alternative to calcium carbonate. According to some aspects, the alkaline earth metal carbonate may include precipitated calcium carbonate (PCC), magnesium carbonate (PMC), and mixtures thereof. The calcium carbonate may be in a crystalline form selected from the group consisting of calcite, vaterite, aragonite, and mixtures thereof.

In embodiments, wherein the calcium carbonate is vaterite, the composite may comprise a porosity ranging from 5% to 70% by volume.

In certain embodiments, the carbon quantum dot compound may be devoid of metal (e.g., lead, cadmium, gold, silver, and compounds thereof), semiconductor materials (e.g., silicon and compounds thereof), or combinations thereof.

Without wishing to be bound by a particular theory, it is believe that carbon quantum dots derived from organic materials, rather than metal or semiconductor materials avoid the toxicity concerns associated with quantum dots derived from the latter materials. In addition, it is believe that the inclusion of the quantum dot in a composite with a salt compound provides the following benefits:
(i) improved resistance against degradation (e.g., oxidative degradation such as hydroxylation and/or oxidation, photodegradation, and/or thermal degradation) as compared to the resistance against degradation of the quantum dot; and/or
(ii) greater dispersibility of the composite in a matrix material than the dispersibility of the quantum dot in the matrix material; and/or
(iii) reduced photobleaching (i.e., photo st of the fluorescent response of the quantum dot in comparison to the fluorescent response of the quantum dot unassociated with the salt; and/or
(iv) a more consistent emission spectrum (e.g., regardless of the ambient radiation) as compared to a fluorescent salt compound and/or quantum dot that is not provided in the composite materials described herein; and/or
(v) greater stability in comparison to the quantum dot that is not provided in the composite materials described herein; and/or
(vi) higher quantum efficiency as compared to a quantum dot that is not provided in the composite materials described herein; and/or
(vii) greater hydrophobicity in comparison to the quantum dot that is not provided in the composite materials described herein; and/or
(viii) greater biocompatilbility in comparison to the quantum dot that is not provided in the composite materials described herein.

In addition, the combination of the salt compound with the quantum dot in a composite allows for the tuning of the composite's fluorescent response due to, among other parameters, the narrow emission bandwidth and the broad excitation band of the quantum dots. By adjusting the average particle size of the quantum dot, the ratio of the salt compound to quantum dot present, and/or the amount and type of salt compound doped with a fluorescent activator, the composite and compositions comprising the composite can be produced with a precise, predetermined fluorescent response.

Herein, certain embodiments of the present invention may tend to be discussed in terms of precipitated calcium carbonate-carbon quantum dot composites. However, the invention should not be construed as being limited to such embodiments.

In certain embodiments, the salt compound-carbon carbon quantum dot compositions have an average particle size ranging from 50 nm to 10,000 nm as measured by TEM.

In certain embodiments, the ratio of the salt compound to the carbon quantum dot in the composite ranges from 99.9:0.1 to 0.1:99.9. In other embodiments, the ratio of the salt compound to the carbon quantum dot in the composite ranges from 99:1 to 1:99. In still other embodiments, the ratio of the salt compound to the carbon quantum dot in the composite ranges from 90:10 to 10:90. In yet other embodiments, the ratio of the salt compound to the carbon quantum dot in the composite ranges from 5:1 to 1:5.

According to some embodiments, the salt compound may include an inorganic fluorescence activator. In certain embodiments, the inorganic fluorescence activator may include at least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium. While these activators are generally used in the disclosed composition in carbonate forms, others forms are also possible, such as sulfates (SO₄), phosphates (PO₄³⁻), tungstates (WO₄) and fluorides (F⁻).

According to some aspects, the inorganic fluorescence activator may comprise up to 10 mol % of the alkaline earth metal compound, such as less than 5 mol % of the alkaline earth metal compound, or even less than 1 mol % of the alkaline earth metal compound. According to certain embodiments, these values are noted for inorganic fluorescence activators that comprise CaCO₃ or MgCO₃.

According to some embodiments, the alkaline earth metal compound may have a crystal structure, and the inorganic fluorescence activator may be contained in the crystal structure. According to other embodiments, the alkaline earth metal compound may comprise a natural ground calcium and/or magnesium carbonate coated with an alkaline earth metal compound doped with a fluorescence activator.

In certain embodiments, the composite may include a salt compound doped with an inorganic fluorescence activator, a salt compound devoid of an inorganic fluorescence activator, and quantum dot(s). In such embodiments, the ratio of salt compound doped with an inorganic fluorescence activator to a salt compound devoid of an inorganic fluorescence activator may range for 99:1 to 1:99.

Additional components may also be included in the salt compound-quantum dot composite. Suitable additional components may include shell materials (e.g., silica shells), stabilizers (e.g., vaterite stabilizers such as polyethylene glycol, ovalbumin, polypeptide, double hydrophilic block copolymers, and anionic starburst dendrimer. embedded gold nanoparticles (NPs), and combinations thereof), and stabilizers (e.g., anionic dispersants, surfactants), rheology control agents/steric stabilizers (e.g., hydroxyethyl cellulose).

### Methods for Producing Salt Compound—Quantum Dot Compositions

According to certain embodiments, the salt compound-carbon quantum dot composite may be produced by providing a natural, organic material, heating the natural organic material to produce carbon quantum dots, and providing a salt compound on the carbon quantum dot. Thus, in certain embodiments the carbon quantum dots may be produced by a hydrothermal process.

In alternative embodiments, the salt compound may partially or completely encapsulate one or more carbon quantum dots. In other embodiments, the one or more carbon quantum dots may be embedded into the salt compound. Thus, in some embodiments, there may be discrete regions in the composite of each of the salt compound and the carbon quantum dots. In other embodiments, the composite may have a substantially homogenous makeup of salt compound and quantum dots dispersed therein, or vice versa.

As used herein, “natural” refers to a material that is derived from naturally occurring materials and/or not substantially synthesized by man-made processes. According to certain embodiments, the natural, organic material is selected from the group consisting of gelatin, bovine serum albumin, grass, coffee grains, flowers, fruit, glucose, and paper waste. The natural, organic material may be provided in an aqueous solution. In other embodiments, the natural, organic material may be provided in ethanol, methanol, isopropanol, formic amaide, dimetyle sulfoxide, dimethyl formic amaide, acetic acid, acetonitrile, methoxy ethanol, tetra hydro furan, benzene, xylene, toluene, cyclohexane, or mixtures thereof.

The heating step may be carried out at a temperature above 100° C., for example, a temperature above 200° C., or a temperature above 300° C.

In other embodiments, the carbon quantum dot may be produced by the steps of:
(i) providing a carbon material (e.g., activated carbon);
(ii) optionally ordering (e.g., orientation) and purifying the carbon material (e.g., via microwave heating);
(iii) hydrothermal reaction; and
(iv) optionally dialysis to provide a fine fraction and a course fraction of carbon quantum dots (e.g., graphene quantum dots).

In still other embodiments, carbon quantum dots may be produced by the steps of
(i) mixing graphite powder with metallic hydrate salts;
(ii) forming an intercalation compound of graphite wherein metal ions are inserted by heating; and
(iii) removing the metal ions from the intercalation compound of graphite, wherein the intercalation compound of the graphite flakes off to form graphene quantum dots.

Such methods are described in further detail in U.S. patent application publication 2015/0118143 to Jeon et al., which is incorporated herein in its entirety.

According to certain embodiments, the carbon quantum dots produced may have an average particle size ranging from 2 nm to 10 nm. In certain embodiments, the carbon quantum dots may have a bimodal particle size distribution, a multimodal particle size distribution, and/or may comprise a statistical mixture to obtain a desired emission spectrum. As discussed in further detail herein, the fluorescent response of the composite may be tunable based on the size of the quantum dots.

In certain embodiments, the salt compound can be provided on the carbon quantum dot by precipitating the salt compound onto the quantum dot. For example, the precipitating step may be carried out by providing two or more reactants selected from the group consisting of fluorides, chlorides, bromides, iodides, acetates, formates, citrates, sulfates, carbonates, hydroxides, phosphates, silicates, molybdates, tungstates, vanadates, titanates, and chromates, of barium, bismuth, chromium, cobalt, copper, gold, iron, lead, nickel strontium, tin, zinc, manganese, tungsten, aluminum, silver, cerium, magnesium, zirconium, titanium, calcium, antimony, or lead. In some embodiments, the reactants are selected from the group consisting of calcium chloride, sodium carbonate, ammonium carbonate, quicklime, hydrated lime, calcium sulfate, ammonium carbonate, ammonium bicarbonate, and combinations thereof.

The alkaline earth metal compound doped with an inorganic fluorescence activator disclosed herein may be obtained via a number of processes. For example, the alkaline earth metal compound doped with a fluorescence activator, such as, for example, precipitated calcium carbonate doped with a fluorescence activator, such as, for example, an impurity such as manganese may be formed according to the following exemplary reaction:

CaCl₂—MnCl₂+(NH₄)₂CO₃→CaCO₃:Mn.

This exemplary process provides an identifying additive including a precipitated calcium carbonate doped with impurities such as manganese, and exhibits a generally rose to orange-red luminescence when irradiated. According to some embodiments of this process, additional inorganic fluorescence activators or impurities may be included, such as, for example, lead, thallium, and cerium salt. Other fluorescence activators are contemplated, may include at least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium.

According to some embodiments, precipitated calcium carbonate may be obtained via another exemplary process. For example, a finely-divided phosphor grade calcium carbonate having a calcite crystalline structure and a very low sodium content may be formed from calcium chloride having a high sodium impurity content, such as, for example, 1.6% sodium chloride. The exemplary process may include forming finely-divided meta-stable vaterite on a continuous basis by continuously adding to an agitated precipitating tank aqueous solutions of calcium chloride and diammonium carbonate in such respective concentrations as to stoichiometrically produce calcium carbonate precipitate and ammonium chloride. The process may further include separating the resulting meta-stable vaterite precipitate from the mother liquor, and then re-suspending the separated vaterite in an aqueous medium. Thereafter, the process may include heating the re-suspended vaterite to a temperature of at least 80° C. for a sufficient period of time to cause the crystal structure of the vaterite to substantially or completely convert to calcite. The process may also include recovering the resulting calcite, which may have a sodium impurity content in the range of from about 10 parts per million (ppm) to 35 ppm. The impurities such as the fluorescence activators mentioned herein, and others, may be incorporated into the calcite crystalline structure during the reactions and/or following the reactions (e.g., in the form of a coating on the calcite crystalline structure).

According to another exemplary process, precipitated calcium carbonate (with or without a fluorescence activator) may be obtained via another process that forms calcium carbonate and ammonium sulfate from gypsum obtained from flue gas desulfurization (FGD), which may be present at electric power plants. According to this exemplary process, FGD gypsum may be obtained from sulfur dioxide SO₂ gas emission control systems used at fossil fuel combustion power plants (e.g., coal-fired power plants) to remove sulfur from the combustion gases using“scrubber” devices. The sulfur dioxide may be derived from any sulfur containing compounds in the fuels. A scrubber uses lime (calcium oxide or calcium hydroxide) or more typically, limestone (calcium carbonate) to react with sulfur dioxide gas to remove the sulfur in a solid form. The scrubbing reaction uses a limestone (CaCO₃)-water slurry to produce calcium sulfite (CaSO₃) according to the following exemplary reaction:

CaCO₃ (solid)+SO₂ (gas)→CaSO₃ (solid)+CO₂ (gas).

Thereafter, the CaSO₃ (calcium sulfite) may be further oxidized to produce CaSO₄.2H₂O (FGD gypsum) according to the following exemplary reaction:

CaSO₃ (solid)+H₂O (liquid)+½O₂ (gas)→CaSO₄ (solid)+H₂O Hydration CaSO₄.½H₂O+1½H₂O→CaSO₄.2H₂O.

Thereafter, the exemplary process may further include a chemical reaction of FGD gypsum (CaSO₄.2H₂O) with ammonium carbonate ((NH₄)₂CO₃) to produce ammonium sulfate ((NH₄)₂SO₄) and calcium carbonate (CaCO₃) according to the following exemplary reaction:

(NH₄)₂CO₃+CaSO₄.2H₂O→(NH₄)₂SO₄+CaCO₃+2H₂O.

The impurities such as the fluorescence activators mentioned herein, and others, may be incorporated into the resulting precipitated calcium carbonate structure during the reactions and/or following the reactions (e.g., in the form of a coating on the calcium carbonate).

In one embodiment, a traditional process for making PCC (i.e., the lime cycle) may be used. In this process, the fluorescence activator, which may be in the form of a water soluble or water reactive salt, is added to the hydrated lime slurry obtained from the slaking process.

In another embodiment, fluorescent calcium carbonate may be made by mixing solutions of calcium chloride (CaCl₂) and sodium carbonate (Na₂CO₃). The PCC generated (which may comprise mainly vaterite polymorph) may be then dispersed in a solution of carbon quantum dots (CQDs). CQDs may be manufactured from gelatin, as discussed in the examples below, or via processes known in the art. Dispersion of the PCC in the CQD solution may occur, for example, under constant agitation. The final product may emit blue fluorescence under UV (365 nm) irradiation.

In another embodiment, fluorescent calcium carbonate may be made by mixing solutions of calcium sulfate (CaSO₄ and ammonium carbonate ((NH₄)₂CO₃). The PCC generated (which may comprise mainly vaterite polymorph) may be then dispersed in a solution of CQDs. The dispersion of the PCC may occur under constant agitation. The final product may emit blue fluorescence under UV (365 nm) irradiation.

Alternate routes may include using mixtures of vaterite, calcite, and aragonite as substrates. Using amorphous PCC as substrate with subsequent crystallization to vaterite is also possible. Further, ultrafine untreated precipitated calcium carbonates (commercially available as Socal® UP) may also be used as a substrate.

The quantum dots may be physisorbed or chemisorbed on salt compounds such as precipitated calcium carbonate and/or ground calcium carbonate.

Fluorescent calcium carbonate made by the exemplary methods of paragraphs [0041] and [0042] may be used, for example, in packaging, labeling, coating, and security applications. As one example, UV irradiation may be used to track packages marked with fluorescent calcium carbonate composite. Further applications of the fluorescent calcium carbonate composite of paragraphs [0041] and [0042] may be found in optical brighteners and cosmetics.

Other processes for forming the alkaline earth metal compound doped with an inorganic fluorescence activator or the identifying additive including alkaline earth metal compound are contemplated.

According to certain embodiments, the precipitated salt compound such as a precipitated calcium carbonate produced may have an average particle size ranging from 50 nm to 10,000 nm as measured by TEM.

In alternate embodiments, the salt compound combined with the quantum dot to form a composite via mechanical attachment, for instance via attachment of the quantum dot to the salt compound.

### Security Markings, Labels, and Packaging

Compositions and methods according to exemplary aspects of this disclosure may enable the provision of markings, labels and packaging that reduce the likelihood of mimicking, copying, and/or counter-fitting of name-brand products. For example, the compositions according to some embodiments may be included in labels or packaging and thereby provide identifying markings that are difficult to mimic or copy. Such compositions may be used as coating compositions, papermaking compositions, sizing compositions, ink compositions, varnish compositions, and/or additives for inclusion in polymer films and metal articles (e.g., drilling equipment).

According to some embodiments, a composition may include an aqueous base and salt compound-quantum dot composite. The composition may be configured to emit a fluorescent response when irradiated, and the composition may be configured as at least one of a coating composition, a paper making composition, a sizing composition, an ink composition, a varnish composition, and a polymer composition. According to some embodiments, a product may include the composition.

According to some embodiments, the fluorescent response may include a predetermined fluorescent signature configured to be used as an identifying characteristic. For example, the predetermined fluorescent signature may include at least one of a brand label, a watermark, a barcode, a quick response code, a symbol, and a label configured to display observable evidence of a physical event or thermal event. According to some embodiments, the predetermined fluorescent signature may include a predetermined emission spectrum. For example, a spectrometer may be used to determine whether the fluorescent signature has a predetermined emission spectrum indicating identification or authenticity.

According to some embodiments, the fluorescent signature may be configured such that it is not visible to the naked eye, but detectable with an appropriate spectrometer. For example, the fluorescent signature may be configured such that it is not visible to the naked eye in the presence of natural light or ultraviolet light. Such embodiments of fluorescent signature may be configured to be detected by an appropriate spectrometer. Such embodiments may be difficult (or impossible) to copy via electronic devices such as, for example, photocopiers, cameras, smart phones, and/or similar copying devices. According to some embodiments, the fluorescent signature may be configured such that it is visible to the naked eye, for example, in the presence of natural light, infrared radiation, and/or ultraviolet light.

According to some embodiments, the composition may be configured to emit the fluorescent response when irradiated at a predetermined wavelength. For example, the salt compound-carbon quantum dot composite may be configured such that the composition emits radiation at a different wavelength from that with which it was irradiated in the presence of ultraviolet light. For example, according to some embodiments, the composition may be configured to emit energy above, for example, about 350 nanometers in response to radiating the composition with, for example, ultraviolet light below about 450 nanometers. According to some embodiments, the composition may be configured to emit energy above, for example, about 400 nanometers in response to radiating the composition with, for example, ultraviolet light below about 400 nanometers.

According to other embodiment, the composition may be configured to emit radiation at a predetermined wavelength, regardless of the wavelength of radiation the composition is irradiated with.

According to some embodiments, a composition may comprise a base comprising at least one identifying additive. The at least one identifying additive may include a salt compound-quantum dot composite. According to some embodiments, a composition may include an aqueous base and at least one identifying additive.

The at least one identifying additive may be configured such that the composition emits fluorescent light having an identifying characteristic different from a characteristic of a surface against which the identifying characteristic is viewed. For example, one or more sides of packaging (e.g., a box) may have a first visual characteristic that provides a background for a second visual characteristic provided by the composition, which may take the form of a marking, such as, for example, a shape, symbol, or region within the background. For example, the at least one identifying additive may be configured such that the composition emits fluorescent light, for example, in the presence of ultraviolet light or infrared radiation.

According to some embodiments, the identifying characteristic may include at least one of a brand label, a watermark, a barcode, a quick response code, a symbol, and a label configured to display observable evidence of a physical event or thermal event. According to some embodiments, the identifying characteristic may include a predetermined emission spectrum. According to some embodiments, the at least one identifying additive may be configured such that the composition emits fluorescent light in the presence of ultraviolet light or infrared radiation.

According to some embodiments, the identifying characteristic may be configured to facilitate identification of an object (e.g., a product) associated with the surface. According to some embodiments, the identifying characteristic may be configured to facilitate identification of a source (e.g., a manufacturer or marketer) of an object associated with the surface.

According to a further aspect, the identifying characteristic may include at least one of a predetermined wavelength and a predetermined intensity. According to some aspects, the predetermined wavelength may range from about 100 nm to about 1400 nm, such as from about 100 nm to about 750 nm, from as 100 nm to about 400 nm, from about 280 nm to about 1400 nm, 315 nm to about 1400 nm, from about 280 nm to about 750 nm.

According to one aspect, the composition may comprise mixtures of separately prepared salt compound-quantum dot composites and/or fluorescent carbonates, such as the ones described herein, including mixtures of calcium carbonate, barium carbonate, and magnesium carbonate, to give a multi-wavelength response for a given excitation source. In this embodiment, the intensities of the different wavelength responses can be adjusted by changing the ratios of the separately prepared salt compound-quantum dot composites and/or fluorescent carbonates.

According to still a further aspect, the at least one identifying additive may comprise up to 100 wt % of the composition, such as less than 95 wt. % of the composition, or less than 80 wt. % of the composition, or less than 70 wt. % of the composition, or less than 60 wt. % of the composition, or less than 50 wt % of the composition, or less than 40 wt. % of the composition, or less than 30 wt % of the composition, or less than 20 wt. % of the composition, or less than 10 wt. % of the composition, or less than 1 wt. % of the composition.

According to some embodiments, the composition may be configured as at least one of a coating composition, a paper making composition, a sizing composition, an ink composition, a varnish composition, and a polymer composition. For example, a product (e.g., paper product or plastic product) may include the composition, and have a brightness, defined in TAPPI Standard T452, which refers to the percentage reflectance to light of a 457 nm wavelength according to methods well known to those of ordinary skill in the art.

In one embodiment, there is disclosed a method for providing identifying markings on paper or packaging may include providing at least one composition in the paper or packaging, or on a surface of the paper or packaging. According to some embodiments of the method, the composition may include at least one identifying additive including a salt compound-quantum dot composite.

The compositions and methods according to some embodiments disclosed herein may be useful for providing labels and packaging that are not easily mimicked or copied. This may provide additional security against the distribution and marketing of products that mimic, copy, or provide counter-fit versions of name-brand products. For example, manufacturers of name-brand or luxury brand products may incorporate the compositions into packaging or labels, so that it is relatively easy to determine whether the product inside the packaging, or inside packaging including a label affixed thereto, is genuine. They may also be used to authenticate articles (e.g., drilling equipment) that require rigorous specifications avoid failure during use, which could result in damage to property and/or casualties.

The packaging or label to be protected may include markings (e.g., such as a symbol, shape, and/or region of the packaging (e.g., a region within a larger background)) that emit fluorescent light that identifies the product or source of the product as being genuine. The portion of the packaging or label including the composition may be configured to emit a fluorescent light having a certain wavelength (e.g., color) and/or intensity that is identifiable and/or verifiable, for example, in the presence of ultraviolet light. In one embodiment, the composition may be configured to emit a predetermined emission spectrum, for example, in the presence of ultraviolet light.

According to some embodiments, the portion associated with the composition may be formed as a particular symbol, shape, or region. As a result, the compositions and methods may facilitate relative ease of inspection of the packaging and/or products to determine whether they are genuine or come from the genuine source. According to other embodiments, the compositions and methods may facilitate customization of a product for a particular person or persons. Thus, such packaging and labels may be desirable for use with name-brand or luxury-brand products, such as, for example, designer fashion products and pharmaceutical products.

### Optical Brightening Agents

According to another aspect, an optical brightening agent comprising a salt compound-quantum dot composite is provided. In certain embodiments, the composition includes a base material comprising at least one optical brightener, said optical brightener comprising at least one salt compound-quantum dot composite incorporated into the base material, wherein the composition is configured as at least one of a coating composition, a paper making composition, an ink composition, and a sizing composition.

According to some embodiments, the optical brightener may comprise greater than or equal to about 1.0 wt % of the composition. For example, the optical brightener may comprise greater than or equal to about 1.5 wt % of the composition. According to some embodiments, the optical brightener may be configured to emit fluorescent light, for example, when exposed to ultraviolet light.

For example, according to some embodiments, the optical brightener may be configured to emit energy above, for example, about 350 nanometers in response to radiating the optical brightener with, for example, ultraviolet light below about 450 nanometers. According to some embodiments, the optical brightener may be configured to emit energy above, for example, about 400 nanometers in response to radiating the optical brightener with, for example, ultraviolet light below about 400 nanometers.

According to other embodiment, the optical brightening agent comprising the salt compound-quantum dot composite may be configured to emit radiation at a predetermined wavelength, regardless of the wavelength of radiation the composition is irradiated with. For instance, the salt compound-quantum dot composite may be configured to emit light in the blue region, e.g., light having a wavelength ranging from about 420 nm to about 470 nm. Such a salt compound-quantum dot composite could be used to replace traditional optical brighteners.

Without wishing to be bound by theory, it is believed that an optical brightener including a salt compound-quantum dot composite according to at least some embodiments may increase the perceived whiteness and/or brightness of a product including the optical brightener. In some embodiments, the optical brightener may result in emission of fluorescent light, thereby increasing the perceived whiteness and/or brightness. Thus, the optical brighteners according to at least some embodiments may permit a reduction or elimination of traditional optical brighteners (e.g., organic brightening agents), while substantially maintaining or increasing the perceived whiteness and/or brightness of the products.

For example, the optical brighteners according to at least some embodiments may be configured to excite traditional optical brighteners. Without wishing to be bound by theory, it is believed that traditional optical brighteners absorb energy ranging from about 300 nanometers to about 400 nanometers, with a significant portion (e.g., a majority) of that emission ranging from about 350 nanometers to about 390 nanometers. Optical brighteners according to at least some embodiments disclosed herein (e.g., some precipitated calcium carbonate) may absorb ultraviolet light ranging from about 250 nanometers to about 300 nanometers, and re-emit energy ranging from about 350 nanometers to about 400 nanometers, which may, in turn, boost the performance of traditional optical brighteners. Such brightness may be tested with, for example, a traditional ultraviolet brightness tester and/or a Spectrofluorometer.

According to some embodiments, the composition may be configured as a product (e.g., a paper product) that includes the composition. According to some embodiments, the product including the composition may have a brightness ranging from about 80 to about 100. For example, the product including the composition may have a brightness ranging from about 90 to about 100.

“Brightness,” as expressed herein, is defined in TAPPI Standard T452 and refers to the percentage reflectance to light of a 457 nm wavelength according to methods well known to those of ordinary skill in the art.

Compositions according to some embodiments may be assessed by color with Hunter L* a* b* coordinates. For example, components “L,” “a,” and “b” are color component values of a 3-dimensional color space scale, which may be measured by, for example, a Hunter Ultrascan XE instrument. On the color space scale, “L” is a measure of whiteness, “+a” is a measure of redness, “−a” is a measure of greenness, “+b” is a measure of yellowness, “−b” is a measure of blueness. Whiteness may be measured according to the ASTM-E-313 standard method. It is to be appreciated that the relative color can be “lighter” (e.g., appearing less blue) or “darker” (e.g., appearing more blue). In the case of tint strength, “lighter” color (i.e., pigment having a higher L value) is considered to have the higher tint strength after addition of a darker color.

According to some embodiments, a composition may include an aqueous base and a first optical brightener. The first optical brightener may include salt compound-quantum dot composite, and the composition may include less than or equal to about 1.5 wt % of a second optical brightener (e.g., a traditional optical brightener, for example, an organic brightening agent) relative to the weight of the composition. For example, the second optical brightener may not include a salt compound-quantum dot composite. According to some embodiments, the composition may not include any of the second optical brightener.

According to some embodiments, the composition may include less than or equal to about 10.0 wt % of the second optical brightener relative to the weight of the composition, such as less than 5.0 wt %, less than 1.5 wt %, less than 1.0 wt %, or less than or equal to about 0.5 wt % the second optical brightener relative to the weight of the composition.

According to some embodiments, the second optical brightener may be a traditional optical brightener. For example, the second optical brightener may be a traditional optical brightener and may include at least one organic brightening agent such as, for example, at least one of sulfonated triazole stilbenes, di-sulfonated stilbene biphenyl, coumarins, imidazolines, diazoles, triazoles, benzoxazolines, and biphenyl-stilbenes.

According to other embodiments, the salt compound-quantum dot composite may be used in various other products to provide a fluorescent response. For example, the salt compound-quantum dot composite may be provided in cosmetics such as hair color, nail polish, skin cream, sunscreen, or makeup. In cosmetics, the salt compound-quantum dot composite may act as, for example, a UV absorbent and/or a fluorescing pigment. In other embodiments, the salt compound-quantum dot composite may be provided in an ink, such as a decorative ink or an ink for detecting the presences of pests (e.g., for detecting mice or other rodents). In other embodiments, the salt compound-quantum dot composite may be used for biological applications such as imaging or sensing.

In other embodiments, the salt compound-quantum dot composite may be used as or in proppant materials, weighting agent materials, lubricant materials, fluid loss prevention materials, or cement materials to identify authentic or specific types of such materials. In still other embodiments, the salt compound-quantum dot composite may be used in pharmaceuticals as a security and/or identification marking.

In some embodiments, inorganic biocides, such as, for example, silver, may be chemically and/or physically added onto or into the salt compound-quantum dot composite.

According to certain embodiments, the salt compound-quantum dot composite may be used as a dry powder or in a dispersion, e.g., in an aqueous solution. In some embodiments, these photo-active moieties (quantum dots or doped Packs) may be used to improve the durability/stability of organic polymers exposed to ultraviolet radiation. Without wishing to be bound by theory, it is believed that this improvement is the result of the photoactive moiety 1) absorbing UV photons of a damaging wavelength; and/or 2) absorbing the UV photon and emitting a photon at a longer wavelength; and/or 3) by de-excitation of the macromolecules by energy drain to the carbonate particles. This stabilization may or may not be accompanied by a fluorescent emission in the visible or near infrared regions. Such organic polymers may take the form of plastics, coatings, sealants, and/or composites. In other embodiments, these photo-active moieties may be included in clear coatings/varnishes/lacquers, for example, to improve the stability of an underlying substrate, such as, for example, wood, paper, leather, and/or other natural materials subject to UV degradation or discoloration. According to some embodiments, these exemplary effects/uses may be achieved by the quantum dots and doped Packs, even if they are not both present.

### Example 1

A PCC-carbon quantum dot (CQD) composite was produced using the following steps. 0.8 g gelatin was added to 40 mL water and was dissolved at 40° C. under agitation. Subsequently, the above admixture was poured into a stainless steel autoclave with teflon liner of 50 mL capacity and heated at 200° C. for 3 hours. Finally, the reactor was automatically cooled to room temperature. The resulting light yellow solution was centrifuged at 16,000 rpm for 30 minutes to remove weight precipitate and agglomerated particles and then yielded a light brown aqueous solution of CQDs for further characterization.

Small quantities of CQDs were dispersed in a calcium chloride solution (0.4 mol L⁻¹) under constant agitation. The formation of PCC/CQDs composites was initiated by quick addition of sodium carbonate solution (0.4 mol L⁻¹) into the calcium chloride/CQD mixture and this reaction was allowed to proceed under magnetic stirring at 500 rpm for 24 hours.

A 1:1 ratio PCC-CQD composite and a 1:5 ratio (ratio of CQD to PCC) PCC-CQD composite were made by varying the amount of PCC reactants provided.

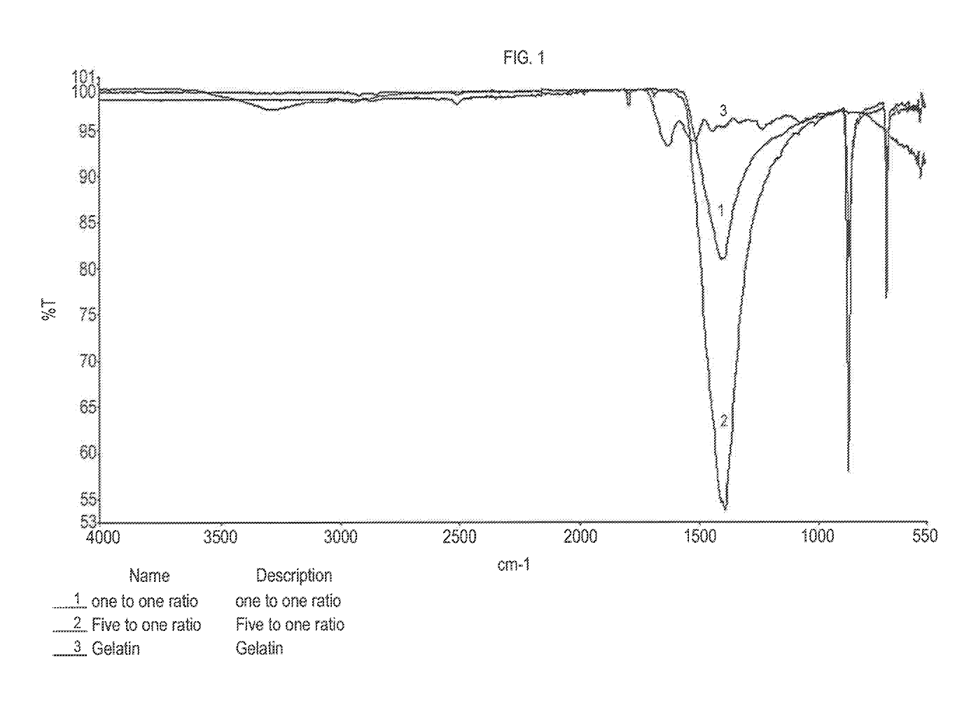

FIG. 1 is the FTIR result for the 1:1 ratio PCC-CQD composite, the 1:5 ratio PCC-CQD composite, and the gelatin.

### Example 2

A PCC-carbon quantum dot (CQD) composite was produced using the following steps.

0.8 g gelatin from bovine skin was added to 40 mL water and was dissolved at 40° C. under agitation. Subsequently, the above admixture was poured into a stainless steel autoclave with a teflon liner of 50 mL capacity and heated at 200° C. for 3 hours. Finally, the reactor was automatically cooled to room temperature. The resulting light yellow solution was centrifuged at 16,000 rpm for 30 minutes to remove precipitate and agglomerated particles and then yielded a light brown aqueous solution of CODs.

PCC was generated by mixing solutions of calcium chloride (CaCl₂) and sodium carbonate (Na₂CO₃). The resulting FCC, which comprised mainly the vaterite polymorph, was dispersed in the CDQs solution under constant agitation for 2 hours. The final product emitted blue fluorescence under UV (365 nm) irradiation.

As an alternate route, PCC was generated by mixing solutions of calcium sulfate (CaSO₄) and ammonium carbonate (NH₄)₂CO₃). The resulting PCC, which comprised mainly the vaterite polymorph, was dispersed in the CDQs solution under constant agitation for 2 hours. The final product emitted blue fluorescence under UV (365 nm) irradiation.

Alternate routes include using mixtures of vaterite, calcite, and aragonite as substrates. Using amorphous PCC as substrate with subsequent crystallization to vaterite is also possible. Further, ultrafine untreated precipitated calcium carbonates (commercially available as Socal® UP) could also be used as a substrate.

Other embodiments of the invention will be apparent to those skilled in the art from consideration of the specification and practice of the exemplary embodiments disclosed herein. It is intended that the specification and examples be considered as exemplary only, with a true scope and spirit of the invention being indicated by the following claims.

1. A composition comprising:
a base material; and
at least one salt compound-quantum dot composite incorporated into the base material, wherein the composition emits a fluorescent response when irradiated.

2. The composition of claim 1, wherein the base material comprises a resin, a fusible powder, a solvent composition.

3. The composition of claim 1, wherein the salt-compound comprises precipitated calcium carbonate.

4. The composition of claim 1, wherein said quantum dot is a carbon quantum dot.

5. The composition of claim 1, wherein the fluorescent response comprises a predetermined fluorescent signature configured to be used as an identifying characteristic chosen from a brand label, a watermark, a barcode, a quick response code, a symbol, and a label configured to display observable evidence of a physical event or thermal event.

6. The composition of claim 1, wherein the predetermined fluorescent signature comprises at least one emission spectrum configured to emit the fluorescent response when irradiated at a predetermined wavelength.

7. The composition of claim 1, wherein the ratio of the salt compound to the quantum dot in the composite ranges from 99.9:0.1 to 0.1:99.9.

8. The composition of claim 1, wherein the composite is configured such that the composition emits fluorescent light when irradiated with a radiation selected from ultraviolet light and infrared.

9. A label comprising the composition of claim 1.

10. A composition comprising:
a matrix comprising at least one identifying additive comprising:
an alkaline earth metal compound-carbon quantum dot composite, wherein the at least one identifying additive is configured such that the composition emits fluorescent light having an identifying characteristic different from a characteristic of a surface against which the identifying characteristic is viewed.

11. The composition of claim 10, wherein the identifying characteristic is configured to facilitate identification of an object associated with the surface, or a source of an object associated with the surface.

12. The composition of claim 10, wherein the salt compound is an alkaline earth metal carbonate.

13. The composition of claim 12, wherein the alkaline earth metal carbonate is doped with a fluorescence activator.

14. The composition of claim 13, further comprising a second salt compound devoid of a fluorescence activator.

15. The composition of claim 10, wherein the identifying characteristic comprises a predetermined emission spectrum.

16. The composition of claim 10, wherein the composition is configured as at least one of a coating composition, a paper making composition, a sizing composition, an ink composition, a varnish composition, and a polymer composition.

17. (canceled)

18. A marking, label, or packaging for identifying at least one of an object and a source of the object, the marking, label or packaging comprising:
a surface associated with the marking, label or packaging; and
the composition of claim 1,
wherein the composition is configured as at least one of a coating composition, a paper making composition, a sizing composition, an ink composition, a varnish composition, and a polymer composition.

19. (canceled)

20. A The composition claim 1,
wherein the composition is configured as at least one of a coating composition, a paper making composition, an ink composition, and a sizing composition.

21. A composition comprising:
a base material comprising a first optical brightener, said first optical brightener comprising:
an alkaline earth metal compound-quantum dot composite,
wherein the composition comprises less than or equal to about 1.5 wt % of a second optical brightener relative to the weight of the composition, wherein the second optical brightener does not include the fluorescence activator.

22. The composition of claim 1, wherein
the base material is an aqueous base,
the at least one salt compound-quantum dot composite is a first optical brightener,
the composition comprises a second optical brightener, and
for a given brightness of a product including the composition, the composition comprises less of the second optical brightener than the first optical brightener.

23-45. (canceled)
